(19) United States
(12) Patent Application Publication
(10) Pub. No.: US 2015/0350763 A1
(43) Pub. Date: Dec. 3, 2015

(54) EARBUD HEADPHONE SET WITH BEHIND-THE-NECK MAGNETIC SPEAKER WIRE CLAMPS

(71) Applicants: Jeff Chadbourne, Sacramento, CA (US); Stuart G. Gherini, Sacramento, CA (US)

(72) Inventors: Jeff Chadbourne, Sacramento, CA (US); Stuart G. Gherini, Sacramento, CA (US)

(21) Appl. No.: 14/289,479

(22) Filed: May 28, 2014

(51) Int. Cl. H04R 1/10

(52) U.S. Cl. CPC H04R 1/1033

(57) ABSTRACT

An earbud headphone set with adjustable behind-the-neck magnetic speaker wire clamps comprising an audio source electrical connector, a length of four-conductor speaker wire, a Y-junction, a first and second length of two-conductor speaker wire, a first and second adjustable magnetic speaker wire clamp, and a first and second loudspeaker. First and second adjustable magnetic speaker wire clamps are each: (i) permanently attached the substantially longer speaker wire, (ii) reversibly slideably attached and reversibly rigidly attached to the substantially longer speaker wire, or (iii) reversibly rigidly attached to the substantially longer speaker wire. Earbud headphone set with adjustable behind-the-neck magnetic speaker wire clamps may further comprise a microphone located on the length of four-conductor speaker wire, the Y-junction, or the first or second length of two-conductor speaker wire.

### BACKGROUND OF THE INVENTION

1. Field of the Invention

This invention pertains to audio headphones or electronic devices that receive audio signals from another electronic device to produce sound therefrom and project the sound directly into the ears of the person wearing the headphones, doing so with two small loudspeakers, one positioned next to each ear of the wearer. Specifically, this invention pertains to earbud headphones, which are headphones that attach to the ears of the wearer by inserting each small loudspeakers or an attachment thereto into the ear canal of each ear.

2. Description of Related Art

There are many earbud headphones in the prior art, however, there are none that address the problem resulting from the tendency of prior art earbud headphones to pull out of or fall from the ear canals of the wearer in an unintentional way to cause a problematic disruption in audio listening. Prior art earbud headphones tend to pull out of or fall from the ear canals of the wearer as a result of the weight of the earbud headphones, the weight of the attached speaker wires, and/or the attachment itself of the earbud headphones to the audio signal source electronic device through the attached speaker wires, which can pull the earbud headphones out of one or both of the wearer's ear canals, to eject the loudspeakers from proximity to the wearer's ears. Even prior art earbud headphones with magnetic clamps do not prevent this occurrence because the clamps are not in use when earbud headphones are in the ear canals of the wearer. The earbud headphones of this invention are first address this problem and certainly first to solve this problem in the particular way described here within this patent application including behind-the-neck magnetic speaker wire clamps to prevent the earbud headphones from pulling or falling from the ear canals of the wearer.

### BRIEF SUMMARY OF THE INVENTION

It is an aspect of earbud headphone set with behind-the-neck magnetic speaker wire clamps to provide an earbud headphone set with substantially longer speaker wires leading to each of the two small loudspeakers than those of prior art earbud headphones, so that the substantially longer speaker wires are long enough to travel from the chest of the wearer, around the neck of the wearer, to reach the back of the neck, and then travel from there up to the ears of the wearer, with added slack therein to allow full travel of neck and head movement without any appreciable tension on the speaker wires running between the two magnetic speaker wire clamps magnetically connected together and the ears of the wearer.

It is an aspect of earbud headphone set with behind-the-neck magnetic speaker wire clamps to provide an earbud headphone set with at least two magnetic speaker wire clamps that are each: (i) permanently attached the substantially longer speaker wire, (ii) reversibly slideably attached and reversibly rigidly attached to the substantially longer speaker wire, or (iii) reversibly rigidly attached to the substantially longer speaker wire.

It is an aspect of a permanently attached magnetic speaker wire clamp to be rigidly and permanently attached to the substantially longer speaker wire. In permanent attachment modes, magnetic speaker wire clamps are attached to the substantially longer speaker wire in one piece and do not comprise two halves that are reversibly attachable to each other.

It is an aspect of a reversibly slideably attached and reversibly rigidly attached magnetic speaker wire clamp to comprise two halves that are reversibly attachable to each other.

It is an aspect of a reversibly slideably attached and reversibly rigidly attached magnetic speaker wire clamp to comprise a male half and a female half, which are capable of clamping together or mating together around a length of speaker wire to reversibly slideably attach and reversibly rigidly attach to the speaker wire.

It may be an aspect of the male half of magnetic speaker wire clamp to comprise at least two tapered leader pins that are used to mate with or connect with at least two bushing holes on the female half of magnetic speaker wire clamp.

It may be an aspect of the female half of magnetic speaker wire clamp to comprise at least two bushing holes that are used to mate with or connect with at least two tapered leader pins on the male half of magnetic speaker wire clamp.

Magnetic speaker wire clamp can be reversibly slideably attached to a speaker wire by lightly pressing male and female halves together by inserting the at least two tapered leader pins of the male half into the at least two bushing holes of the female, one tapered leader pin per bushing hole, with a length of speaker wire running between the at least two tapered leader pins, and lightly pressing the tapered leader pins into the bushing holes, without firmly clamping male and females halves together, to leave space between the male and female halves, to provide reversible slideable attachment of magnetic speaker wire clamp to the speaker wire, that allows the magnetic speaker wire clamp to loosely connect to the speaker wire and slide along the length of the speaker wire to any desired position thereon without becoming separated from the speaker wire.

When magnetic speaker wire clamp is at the desired location on the speaker wire, magnetic speaker wire clamp can be reversibly rigidly attached to a speaker wire by firmly pressing the male and female halves together to tightly clamp the two halves together thereby tightly clamping the speaker wire between the male and female halves in a rigid fashion.

Male and female halves can be detached from rigid attachment to each other and the speaker wire by pulling the male and female halves slightly apart by hand, without complete removal of tapered leader pins from bushing holes, thereby unclamping the magnetic speaker wire clamp from the speaker wire to allow for additional adjustment of magnetic speaker wire clamp along the length of the speaker wire, at which point it may be reversibly rigidly attached again.

Male and female halves can be detached from reversible slideable attachment or reversibly rigid attachment to the speaker wire by pulling the male and female halves completely apart by hand thereby completely removing all tapered leader pins from all bushing holes and ready for reversible slideable reattachment or reversible rigid reattachment to the speaker wire at any time.

It is an aspect of a reversibly rigidly attached magnetic speaker wire clamp to comprise two halves that are reversibly attachable to each other.

It is an aspect of a reversibly rigidly attached magnetic speaker wire clamp to comprise a male half and a female half, which are capable of clamping together or mating together around a length of speaker wire to reversibly slideably attach and reversibly rigidly attach to the speaker wire.

It may be an aspect of the male half of magnetic speaker wire clamp to comprise a latch that is used to mate with or connect with a latch receiver on the female half of magnetic speaker wire clamp.

It may be an aspect of the female half of magnetic speaker wire clamp to comprise a latch receiver that is used to mate with or connect with a latch on the male half of magnetic speaker wire clamp.

It may be an aspect of male and female halves of magnetic speaker wire clamp to comprise a hinge member that is permanently attached to both male and female halves to provide a pivotal connection there between.

At any desired location on the speaker wire, magnetic speaker wire clamp can be reversibly rigidly attached to the speaker wire by firmly pressing the male and female halves together so that the latch on the male half snaps into latch receiver on the female half to tightly clamp the two halves together thereby tightly clamping the speaker wire between the male and female halves in a rigid fashion.

Male and female halves can be detached from rigid attachment to each other and the speaker wire by pulling the male and female halves slightly apart by hand, to remove latch from latch receiver, thereby unclamping the magnetic speaker wire clamp from the speaker wire to allow for additional adjustment of magnetic speaker wire clamp along the length of the speaker wire, at which point it may be reversibly rigidly attached again.

It is an aspect of each magnetic speaker wire clamp to comprise a magnetic insert that is a magnetically charged solid material that is partially or fully encapsulated by magnetic speaker wire clamp.

It is an aspect of each magnetic speaker wire clamp to magnetically attract to another magnetic speaker wire clamp.

It is an aspect of each magnetic speaker wire clamp to have a tendency to magnetically connect with one and only one other magnetic speaker wire clamp at a time.

It is an aspect of two magnetic speaker wire clamps to be capable of magnetic connected together as a result of a person placing the two magnetic speaker wire clamps in close proximity to each other with their fingers.

It is an aspect of two magnetic speaker wire clamps magnetically connected together to be capable of separation from each other by a person pulling the two magnetic speaker wire clamps apart with their fingers.

It is an aspect of earbud headphone set with behind-the-neck magnetic speaker wire clamps to provide an earbud headphone set wherein the speaker wires for each loudspeaker are capable of magnetically connecting together at a location that is behind-the-neck of the wearer as a result of the at least two magnetic speaker wire clamps, one on each speaker wire, being magnetically connected together, where the speaker wires for each loudspeaker travel from there up to the ears of the wearer, with added slack therein to allow full travel of neck and head movement without any appreciable tension on the speaker wires running between the two magnetic speaker wire clamps magnetically connected together and the ears of the wearer.

It is an aspect of two magnetic speaker wire clamps magnetically connected together to be capable of magnetically disconnecting from each other as a result of a person pulling the two magnetic speaker wire clamps apart with their fingers.

### BRIEF DESCRIPTION OF THE DRAWINGS

FIG. 1 is a top plan view of best mode earbud headphone set with behind-the-neck magnetic speaker wire clamps.

FIG. 2 is a front perspective view of a person wearing earbud headphone set with behind-the-neck magnetic speaker wire clamps with the loudspeakers inserted into the ear canals of the wearer.

FIG. 3 is a front perspective view of a person wearing earbud headphone set with behind-the-neck magnetic speaker wire clamps with the loudspeakers removed from the ear canals of the wearer.

FIG. 4 is a rear perspective view of a person wearing best mode earbud headphone set with behind-the-neck magnetic speaker wire clamps with the loudspeakers inserted into the ear canals of the wearer.

FIG. 5 is a rear perspective view of a person wearing best mode earbud headphone set with behind-the-neck magnetic speaker wire clamps with the loudspeakers removed from the ear canals of the wearer.

FIG. 6 is a perspective view of best mode earbud headphone set with behind-the-neck magnetic speaker wire clamps with behind-the-neck magnetic speaker wire clamps reversibly rigidly attached to the speaker wires and magnetically connected together at a position on the speaker wires that yields a relatively short speaker wire length leading to the two loudspeakers.

FIG. 7 is a perspective view of best mode earbud headphone set with behind-the-neck magnetic speaker wire clamps with behind-the-neck magnetic speaker wire clamps reversibly rigidly attached to the speaker wires and magnetically connected together at a position on the speaker wires that yields a relatively long speaker wire length leading to each of the two loudspeakers.

FIG. 8 is a top perspective view of best mode magnetic speaker wire clamp with male and females halves positioned above and below a length of speaker wire in preparation for reversible slideable attachment and/or reversible rigid attachment thereto.

FIG. 9 is a top perspective view of best mode magnetic speaker wire clamp with male and females halves tightly clamped together around a length of speaker wire to form a reversible rigid attachment thereto.

FIG. 10 is a bottom perspective view of magnetic speaker wire clamp with two tapered leader pins and magnetic insert in the female half, with male and females halves tightly clamped together around a length of speaker wire to form a reversible rigid attachment thereto.

FIG. 11 is a bottom perspective view of magnetic speaker wire clamp with two tapered leader pins and magnetic insert in the female half, with male and females halves positioned above and below a length of speaker wire in preparation for reversible slideable attachment and/or reversible rigid attachment thereto.

FIG. 12 is a top perspective view of a magnetic speaker wire clamp permanently attached to a speaker wire.

FIG. 13 is a top plan view of best mode earbud headphone set with behind-the-neck magnetic speaker wire clamps with a microphone located inside the Y-junction electrical component.

FIG. 14 is a top plan view of best mode earbud headphone set with behind-the-neck magnetic speaker wire clamps with a microphone located on the length of four-conductor speaker wire.

FIG. 15 is a top plan view of best mode earbud headphone set with behind-the-neck magnetic speaker wire clamps with a microphone located on one of the two lengths of two-conductor speaker wire.

FIG. 16 is a perspective view of a magnetic speaker wire clamp in clamshell mode with magnetic speaker wire clamp open.

FIG. 17 is a perspective view of a magnetic speaker wire clamp in clamshell mode with magnetic speaker wire clamp closed.

FIG. 18 is a perspective view of a magnetic speaker wire clamp in clamshell mode with magnetic speaker wire clamp reversibly rigidly attached to a length of speaker wire.

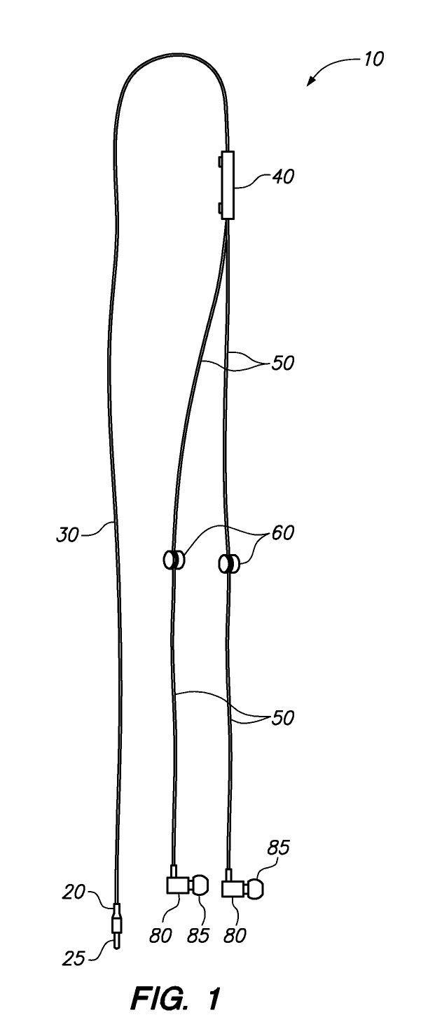

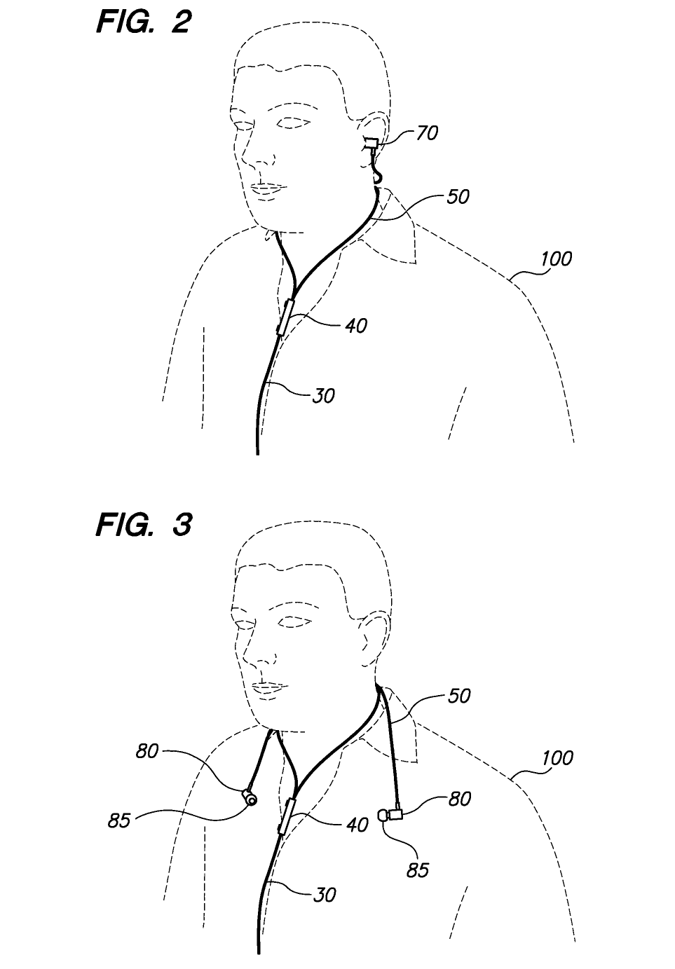

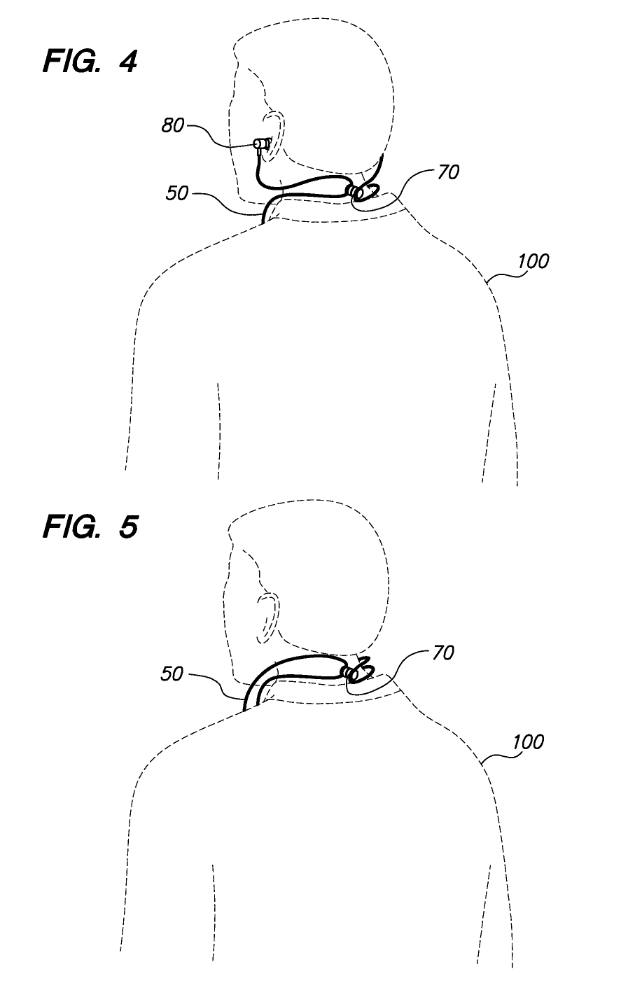

DEFINITION LIST

| Term | Definition |
|---|---|
| 10 | Earbud Headphone Set With Behind-the-Neck Magnetic Speaker |
| | Wire Clamps |
| 20 | Audio Source Electrical Connector |
| 25 | Jack Plug or Pin Electrical Connector |
| 30 | Four-Conductor Speaker Wire |
| 40 | Y-Junction for Speaker Wire |
| 50 | Two-Conductor Speaker Wire |
| 55 | Speaker Wire with At Least 3 Conductor Strands |
| 60 | Magnetic Speaker Wire Clamp |
| 62 | Male Half of Magnetic Speaker Wire Clamp |
| 63 | Latch |
| 64 | Tapered Leader Pin |
| 65 | Magnetic Insert |
| 66 | Female Half of Magnetic Speaker Wire Clamp |
| 67 | Latch Receiver |
| 68 | Bushing Hole |
| 69 | Flexible Hinge Member |
| 70 | Two Magnetic Speaker Wire Clamps Magnetically Connected |
| | Together |
| 80 | Loudspeaker |
| 85 | Ear Canal Insert |
| 90 | Microphone |
| 100 | Person Wearing Earbud Headphones |

### DETAILED DESCRIPTION OF THE INVENTION

Earbud headphone set with behind-the-neck magnetic speaker wire clamps 10 comprises: an audio source electrical connector 20, a length of four-conductor speaker wire 30, a Y-junction 40, a first and second length of two-conductor speaker wire 50, a first and second magnetic speaker wire clamp 60, and a first and second loudspeaker 80.

The length of four-conductor speaker wire 30 is a length of speaker wire with a first, a second end, and at least four continuous strands of conductive material running from the first end to the second end that have electrical continuity from first end to second end. Each of at least four continuous strands of conductive material is electrically shielded from each other and from the outside with an insulation cover layer. Length of four-conductor speaker wire 30 is speaker wire capable of electronically driving two loudspeakers. The length of four-conductor speaker wire 30 may be split on the second end to create two lengths of two-conductor speaker wire at the split end, wherein the two lengths of two-conductor speaker wire, in this mode, are the first and second lengths of two-conductor speaker wire 50, as stated below.

Audio source electrical connector 20 is an electrical connector that functions to reversibly electrically couple each conductor in the length of four-conductor speaker wire 30 to an audio source device (not depicted), such as a music player, smart phone, television, stereo, or similar electronic device, to thereby receive electronic signals from the audio source device, which are used by the two loudspeakers 80, as described below, to create sound and project it into the ears of the headphone wearer 100. Audio source electrical connector 20 also functions to reversibly physically attach the length of four-conductor speaker wire 30 to the audio source device to provide a semi secure physical connection thereto. Audio source electrical connector 20 is rigidly attached to the first end of the length of four-conductor speaker wire 30 as depicted.

Audio source electrical connector 20 is an oblong-shaped electrical connector with a first and second end. There is a jack plug or pin electrical connector 25 at the first end and a set of shielded electrical connections at the second end. Shielded electrical connections are physically reinforced electrical connections between the jack plug or pin electrical connector 25 and each conductor in the length of four-conductor speaker wire 30. Jack plug or pin electrical connector 25 is a male plug or pin that is sized to make a reversible press fit connection inside a jack or socket electrical connector (not depicted) on the audio signal source device (not depicted). Jack plug or pin electrical connector 25 is made of conductive material such as metal. Jack plug or pin electrical connector 25 is divided along its length into at least four separate electrically insulated segments. The at least four separate electrically insulated segments are used to form four separate electrical continuities between each segment and each of the at least four conductor strands in the length four-conductor speaker wire 30. Four separate electrical continuities and four conductor speaker wire 30 are required to drive the two loudspeakers 80, one loudspeaker 80 for each ear of the wearer 100, with two conductors required to drive each loudspeaker 80. Shielded electrical connections to each of the four conductor strands in the four-conductor speaker wire 30 may be accomplished by any known means. In best mode, audio source electrical connector 20 is a male headphone jack connector.

As stated, the first end of the length of four-conductor speaker wire 30 is permanently attached to audio source connector 20. The second end of the length of the length four-conductor speaker wire 30 is permanently attached to Y-junction 40. Y-junction 40 is an oblong-shaped rigid electrical connector with a top end and a bottom end. The bottom end of Y-junction 40 is rigidly attached to the second end of the length of four-conductor speaker wire 30. The top end of Y-junction 40 is rigidly attached to the first end of the first length of two-conductor speaker wire 50 and the first end of the second length of two-conductor speaker wire 50. Thus, one wire 30 extends from the bottom end of Y-junction 40 and two wires 50 extend from the top end of Y-junction 40 to yield a junction that is shaped like a “Y”. Y-junction 40 is a rigid electrical insulation shield that covers and protects the junction area from breaking, running, or any type of movement that may occur from the pulling on any of the speaker wires 30,50 extending from the Y-junction 40. The two lengths of two-conductor speaker wire 50 that extend from the top of Y-junction 40 are the first and second lengths of two-conductor speaker wire 50.

In one mode, the second end of four-conductor speaker wire 30 is “split” to yield the first and second lengths of two-conductor speaker wire 50 on the split or second end, so that each of the four stands of conductive material in four-conductor speaker wire 30 extend uncut or unbroken from the first end of four-conductor speaker wire 30, through Y-junction 40, to the second ends of the first and second lengths of two-conductor speaker wire 50. Rigid electrical insulation covering may be accomplished by any known means.

Alternately, Y-junction 40 may also function to physically and electrically couple three separate lengths of speaker together to make the Y-junction by coupling the second end of four-conductor speaker wire 30 and the first ends of the first and second lengths of two-conductor speaker wire 50 to the Y-junction, so that each of the four stands of conductive material within the length of four-conductor speaker wire 30 has electrical continuity with one of the two strands of conductive material in the first and second length of two-conductor speaker wire 50. Electrical coupling may be accomplished by any known means.

First and second lengths of two-conductor speaker wire 50 each comprise a first end, a second end, and at least two continuous strands of conductive material running from the first end to the second end that have electrical continuity from the first end to second end. Each of at least two continuous strands of conductive material is electrically shielded from each other and from the outside with an insulation cover layer. Each of first and second lengths of two-conductor speaker wire 50 is speaker wire capable of electronically driving one loudspeaker.

First and second lengths of two-conductor speaker wire 50 each have a length that is longer than that of a typical headphone (not depicted). This is because with the current design, first and second lengths of two-conductor speaker wire 50 must each be long enough to travel from the chest of the wearer 100, around the neck of the wearer 100, to reach the back of the neck, and then travel from there up to the ears of the wearer 100, with added slack therein to allow for full travel neck and head movement without creating tension on the first or second lengths of two-conductor speaker wire 50 between ‘two magnetic speaker wire clamps magnetically connected together’ 70 and each of the ears of the wearer 100 as described below. Whereas the first and second lengths of two-conductor speaker of prior art headphones must only travel from the chest to the ears of the wearer 100 and not to the back of the neck of the wearer 100 and then to the ears of the wearer 100. First and second lengths of two-conductor speaker wire 50 each have a length that is about 1.5-2 times longer than that of a typical headphone (not depicted). In best mode, first and second lengths of two-conductor speaker wire 50 each have a length that is about 21-27 inches.

The second end of each first and second length of two-conductor speaker wire 50 is permanently attached to a loudspeaker 80 as depicted. This permanent attachment is both an electrical and physical attachment. Electrical attachment occurs with an electrical connection or coupling between each of the conductor strands in the first length of two-conductor speaker wire 50 and the attached loudspeaker 80 and also between each of the conductor strands in the second length of two-conductor speaker wire 50 and the attached loudspeaker 80 so that there is electrically insulated electrical continuity there between for these connections. As stated, electrical coupling must be such so that there are two separate electrical continuities between the audio source device and each of the first and second loudspeakers 80. Physical attachment occurs with rigid or semi rigid protective covering over these electrical connections to prevent movement of the electrical connections when a loudspeaker 80 and/or length of two-conductor speaker wire 50 is pulled or stretched.

Each of the first and second loudspeakers 80 is a loudspeaker, which is an electronic device that is capable of receiving electronic signals from an audio source device and electrically converting those electronic signals into sound waves using vibrating membranes to create sound. Each of the first and second loudspeakers 80 is small loudspeaker that is about the size of a human ear canal or slightly larger. Each of the first and second loudspeakers 80 has two electrical inputs and at least one vibrating membrane. Each vibrating membrane is positioned close to an ear of wearer when the headphones are worn. Each of the first and second loudspeakers 80 is an earbud loudspeaker.

Each of the first and second loudspeakers 80 may be reversibly attached to an ear of the wearer 100 by inserting slightly into the ear canal to form a reversible press fit attachment inside the ear canal, so that the loudspeaker 80 is held inside the ear canal. To remove a loudspeaker 80 from the ear canal, the speaker wire 50 leading to the loudspeaker 80 may be pulled by hand to remove the loudspeaker 80 from the ear.

First and second loudspeakers 80 may each further comprise an ear canal insert 85. Ear canal insert 85 is hollow tubular member with open ends with outer diameter that is slightly smaller than the inner diameter of a human ear canal. One end ear canal insert 85 is attached to the front of loudspeaker 80 and adjacent to the vibrating membrane of the loudspeaker 80. Ear canal insert 85 functions to reversibly attach each loudspeaker to the ear of the wearer 100. Ear canal insert 85 is inserted slightly into the ear canal to form a reversible press fit attachment inside the ear canal, so that the ear canal insert 85 and attached loudspeaker 80 are held in close proximity to the ear of the wearer. To remove an ear canal insert 85 with attached loudspeaker 80 from the ear canal, the loudspeaker 80 or speaker wire 50 leading to the loudspeaker 80 may be pulled by hand to remove ear canal insert 85 with attached loudspeaker 80 from the ear. Best mode loudspeakers 80 include ear canal inserts 85 but are not required.

First and second magnetic speaker wire clamps are each a rigid or semi-rigid planar member about the size of a person's fingernail, or slightly smaller, made of or formed from an insulating or non-conductive material, which acts as a cover layer or covering that encapsulates or partially encapsulates a magnetic insert 65 described below. In best mode, first and second magnetic speaker wire clamps are each cylindrical shaped but can be of any particular shape. First and second magnetic speaker wire clamps each may be: (i) permanently attached to two-conductor speaker wire 50, (ii) reversibly slideably attached and reversibly rigidly attached to two-conductor speaker wire 50, or (iii) reversibly rigidly attached to two-conductor speaker wire 50. Thus, there are three types of attachment of magnetic speaker wire clamp 60 to speaker wire 50.

With the first type of attachment of magnetic speaker wire clamp 60 to speaker wire 50, first magnetic speaker wire clamp 60 may be permanently attached to the first length of two-conductor speaker wire 50 as depicted in FIG. 12. Second magnetic speaker wire clamp 60 may be may be permanently attached to the second length of two-conductor speaker wire 50 as depicted in FIG. 12. Permanent attachment of magnetic speaker wire clamp 60 to two-conductor speaker wire 50 may be accomplished by molding, over-molding, gluing, welding, bolting, or screwing the magnetic speaker wire clamp 60 to two-conductor speaker wire 50. With permanent attachment modes, magnetic speaker wire clamps 60 are not adjustable, as they are permanently attached to speaker wire 50, and thus do not comprise two halves 62,66 that are reversibly attachable to each other as described below. With permanent attachment modes, magnetic speaker wire clamps 60 have a cover layer or covering that is essentially one piece.

With the second type of attachment of magnetic speaker wire clamp 60 to speaker wire 50, first and second magnetic speaker wire clamps each may be, First magnetic speaker wire clamp 60 may be reversibly slideably attached and reversibly rigidly attached the first length of two-conductor speaker wire 50, as depicted in FIGS. 8-11. Second magnetic speaker wire clamp 60 may be reversibly slideably attached and reversibly rigidly attached the second length of two-conductor speaker wire 50, as depicted in FIGS. 8-11. In these modes, magnetic speaker wire clamp 60 comprises: a male half 62 with at least two tapered leader pins 64, a female half 66 with at least two bushing holes 68, and a magnetic insert 65.

Male half 62 is a rigid or semi rigid planar member with a top and bottom surface. Male half 62 is about the size of a person's fingernail or slightly smaller. Male half 62 has at least two taper leader pins 64 protruding from its bottom surface. Each tapered leader pin 64 is a rigid or semi rigid solid cylindrical member with one end rigidly attached to the bottom surface of male half 62. The diameter of each tapered leader pin 64 varies linearly along the length of the rigid or semi rigid solid cylindrical member. The diameter is largest at the base of the rigid or semi rigid solid cylindrical member or attachment end of the rigid or semi rigid solid cylindrical member. The diameter is smallest at the protruding end of the rigid or semi rigid solid cylindrical member or end that is opposite the attachment end of rigid or semi rigid solid cylindrical member. Each tapered leader pin 64 is sized and shaped exactly to make a precise adjustable press fit connection with a bushing hole 68.

Female half 66 is a rigid or semi rigid planar member with a top and bottom surface. Female half 66 is about the size of a person's fingernail or slightly smaller. Female half 66 has at least two bushing holes 68 in it that are cylindrical holes or voids in the rigid or semi rigid planar member running from bottom surface to the top surface. Each bushing hole 68 is sized and shaped exactly to make a precise adjustable press fit connection with a tapered leader pin 64.

Precise adjustable press fit connection is such that each bushing hole 68 may be slightly pressed onto the protruding end of a tapered leader pin 64 and firmly held in position there on the protruding end of a tapered leader 64 from the press fit connection between the two members. Precise adjustable press fit connection is also such that each bushing hole 68 may be more firmly pressed onto tapered leader pin 64 down to the base end of a tapered leader 64 and firmly held in position there from a press fit connection between the two members. Because of the taper on the leader pins 64, this press fit connection is stronger at the base end of the leader pin than at the protruding end of the leader pin.

Magnetic speaker wire clamp 60 can be reversibly slideably attached to a length of two-conductor speaker wire 50 by inserting the at least two tapered leader pins 64 of the male half 62 into the at least two bushing holes 68 of the female half 66, one tapered leader pin 64 per bushing hole 68, with a length of speaker wire 50 running between the at least two tapered leader pins 64, and lightly pressing the tapered leader pins 64 into the bushing holes 68, without firmly clamping male and females halves 62,66 together, to leave space between the male and female halves 62,66 to provide reversible slideable attachment of magnetic speaker wire clamp 60 to length of two-conductor speaker wire 50, that allows the magnetic speaker wire clamp 60 to loosely connect to the speaker wire 50 and slide along the length of the speaker wire 50 to any desired position thereon without becoming separated from the speaker wire 50.

When magnetic speaker wire clamp 60 is at the desired location on the length of two-conductor speaker wire 50, magnetic speaker wire clamp 60 can be reversibly rigidly attached to speaker wire 50 by firmly pressing the male and female halves 62,66 together to tightly clamp the two halves together thereby tightly clamping the speaker wire 50 between the male and female halves 62,66 in a rigid fashion.

Male and female halves 62,66 can be detached from rigid attachment to each other and the length of two-conductor speaker wire 50 by pulling the male and female halves 62,66 slightly apart by hand, without complete removal of tapered leader pins 64 from bushing holes 68, thereby unclamping the magnetic speaker wire clamp 60 from the speaker wire 50 to allow for additional adjustment of magnetic speaker wire clamp 60 along the length of two-conductor speaker wire 50, at which point magnetic speaker wire clamp 60 may be reversibly rigidly attached again.

Male and female halves 62,66 can be detached from reversible slideable attachment or reversibly rigid attachment to the length of two-conductor speaker wire 50 by pulling the male and female halves 62,66 completely apart by hand thereby completely removing all tapered leader pins 64 from all bushing holes 68. Afterwards, male and female halves 62,66 can be reattached at any time by reversible slideable reattachment or reversible rigid reattachment to the speaker wire 50.

In best mode, each magnetic speaker wire clamp 60 comprises six tapered leader pins 64 in the male half 62 and six correlated bushing holes 68 in the female half 66. The more pin and bushing combinations there are in the pin/bushing press fit connection, the greater the friction force in the press fit to yield a more firm connection between these members. A six pin/bushing design yields additional friction and clamping pressure over a two pin/bushing design. Male half 62 may comprise 2 or more tapered leader pins 64. Female half 66 may comprise 2 or more bushing holes 68. The number of tapered leader pins 64 should coincide with the number of bushing holes 68. Magnetic speaker wire clamp 60 may have 2-20 tapered leader pin 64/bushing hole 68 sets.

With the third and final type of attachment of magnetic speaker wire clamp 60 to speaker wire 50, first magnetic speaker wire clamp 60 may be reversibly rigidly attached the first length of two-conductor speaker wire 50, as depicted in FIG. 18. Second magnetic speaker wire clamp 60 may be reversibly rigidly attached the second length of two-conductor speaker wire 50, as depicted in FIG. 18. In these modes, magnetic speaker wire clamp 60 comprises: a male half 62 with a latch 63, a female half 66 with a latch receiver 67, a hinge 69, and a magnetic insert 65. Male half 62 is a rigid or semi rigid planar member with a top and bottom surface. Male half 63 is about the size of a person's fingernail or slightly smaller. Female half 66 is a rigid or semi rigid planar member with a top and bottom surface. Female half 66 is about the size of a person's fingernail or slightly smaller.

In these modes, male half 62 is pivotally attached to female half 66 via a flexible hinge member 69. Flexible hinge member 69 is a resilient oblong planar member with a first end and second end, wherein the first end is rigidly attached to male half 62 and the second end is rigidly attached to female half 66 to pivotally attached male and female halves 62,66. Male and female halves 62,66 are pivotally attached by hinge member 69 to form a clamshell shape that opens and closed like a clamshell. Male and female halves 62,66 close by pressing the two halves 62,66 together. Male half 62 and female half 66 snap together to form a tight connection around a length of two-conductor speaker wire 50. Latch 63 is a tab member that extends from male half 62 to reach female half 66 when the halves are closed. Latch 63 includes a protrusion or lip member. Latch receiver 67 is a depression socket in female half 66 that received latch 62 to form a snap connection therein. Latch receiver 67 includes a groove that is sized to make a press fit connection with the protrusion or lip member on latch 63. Male half 62 and female half 66 snap together when protrusion on latch 63 snaps into the groove on the latch receiver 67.

Male and female halves 62,66 can be detached from rigid attachment to the length of two-conductor speaker wire 50 by pulling the male and female halves 62,66 slightly apart by hand, to remove the protrusion or lip member on latch 63 from the groove on latch receiver 67, thereby unclamping the magnetic speaker wire clamp 60 from the speaker wire 50 to allow for additional adjustment of magnetic speaker wire clamp 60 along the length of two-conductor speaker wire 50, at which point magnetic speaker wire clamp 60 may be reversibly rigidly attached again.

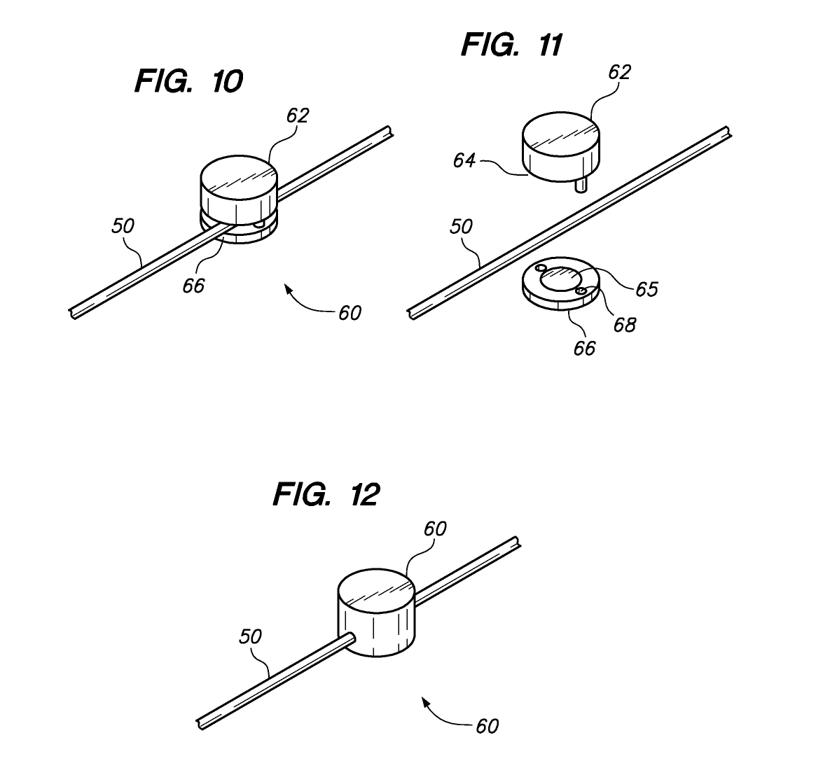

Magnetic insert 65 is a piece of magnetically charged solid material or a magnet. Magnetic insert 65 may be any known material that can retain a magnetic charge for a long period of time so that the molecules in the material are aligned with each other according to the direction of their magnetic poles to yield a magnetic north end a south end of the material. Magnetic insert 65 may be partially or fully encapsulated within male half 62 or female half 68. In best mode, magnetic insert 65 is partially encapsulated into male half 62 as depicted in FIGS. 8-9,16-18. Magnetic insert 65 also may be partially or fully encapsulated within female half 66 as depicted in FIGS. 10-11. Modes with permanent attachment of magnetic speaker clamps 60 to two-conductor speaker wire 50 have magnetic insert 65 fully encapsulated within magnetic speaker wire clamp 60 as depicted in FIG. 12.

Each magnetic speaker wire clamp 60 is magnetically attracted to another magnetic speaker wire clamp 60 because of the magnetic insert 65 in each magnetic speaker wire clamp 60. After a magnetic speaker wire clamp 60 is magnetically connected to another magnetic speaker wire clamp 60, the magnetic attraction is exhausted so to speak and the two magnetically connected magnetic speaker wire clamps 70 do not attract other magnetic speaker wire clamps 60.

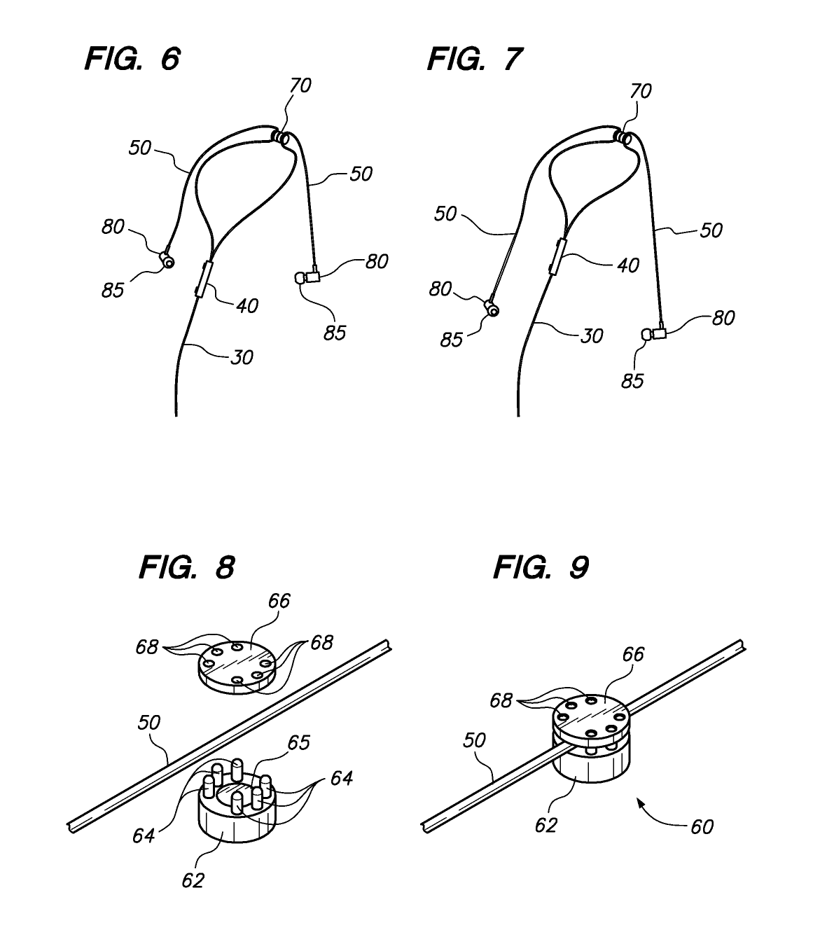

As stated above, each magnetic speaker wire clamp 60 may be adjusted along the length of the two-conductor speaker wire 50 and clamped at a desired location by squeezing the male and female halves 62,66 firmly together by hand. Each magnetic speaker wire clamp 60 may be re-adjusted along the length of the two-conductor speaker wire 50 and clamped at a desired location by pulling apart and then re-squeezing the male and female halves 62,66 firmly together by hand. FIG. 6 depicts earbud headphone set with behind-the-neck magnetic speaker wire clamps 10 with magnetic speaker wire clamps 60 adjusted and clamped to two-conductor speaker wire 50 at a position thereon that yields a relatively short speaker wire length leading to the two loudspeakers, which would be sized for a person 100 with relatively small distance between the back of their neck and their ear canals. FIG. 7 depicts earbud headphone set with behind-the-neck magnetic speaker wire clamps 10 with magnetic speaker wire clamps 60 adjusted and clamped to two-conductor speaker wire 50 at a position thereon that yields a relatively long speaker wire length leading to the two loudspeakers, which would be sized for a person 100 with relatively long distance between the back of their neck and their ear canals.

As stated above, two magnetic speaker wire clamps 60, each attached to a length of two-conductor speaker wire 50, can be magnetically connected together to form two magnetic speaker wire clamps magnetically connected together 70 at a location behind-the-neck of the headphone wearer 100. Two magnetic speaker wire clamps magnetically connected together 70 provides physical resistance to the weight of the earbud headphones 10, the weight of the attached speaker wires 30,50, and/or the attachment itself 25 of the earbud headphones to the audio signal source electronic device through the attached speaker wires 30,50 to prevent such from pulling the loudspeakers 80 from the ears of the wearer 100. However, this resistance is not so strong so as to prevent the wearer from pulling the two magnetic speaker wire clamps magnetically connected together 70 apart from connection by hand with their fingers.

Earbud headphone set with behind-the-neck magnetic speaker wire clamps 10 may further comprise a microphone 90. Microphone 90 is a microphone, which is an electronic device with a vibrating membrane that vibrates according to sound waves passing there through and converts these vibrations into electronic signals that may be used by other electronic devices to convert back to the original sound waves. Microphone 90 functions to receive sound waves originating from the wearer's spoken words or similar or other audio from the proximate area to microphone 90, to convert such into electronic signals that are passed to the audio source device (not depicted), such as a music player, smart phone, television, stereo, or similar electronic device, to thereby transmit electronic signals from microphone 90 to the audio source device, which can be used by audio source device to conduct a phone conversation, video chat conversation, or similar, between the wearer 100 and another person or persons or to receive verbal commands or directives from the earbud headphone wearer 100.

Modes with microphone 90 have different electrical wiring connections than modes without a microphone 90. Three of the four segments on jack plug or pin electrical connector 25 described above are electrically coupled to the first loudspeaker 80, the second loudspeaker 80, and the microphone 90, respectively, where the fourth conductor is electrically coupled to a common or ground signal that is shared by the first loudspeaker 80, the second loudspeaker 80, and the microphone 90, to provide adequate electrical signal connections to the audio source device to electronically drive the first and second loudspeakers 80 as well as the microphone 90 with a four-conductor electrical coupling to the audio source device. One of four continuous strands of conductive material in the four-conductor speaker wire 30 is designated as the ground or common connection and electrically coupled to each of the first loudspeaker 80, the second loudspeaker 80, and microphone 90 in parallel.

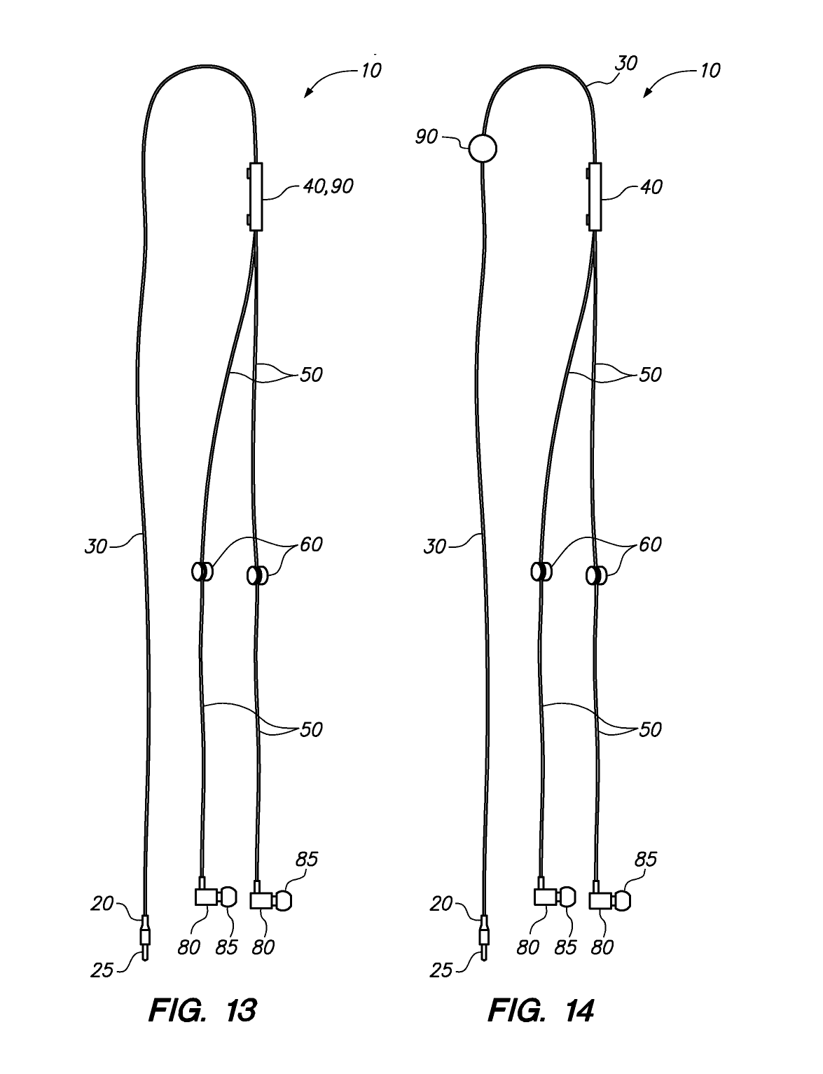

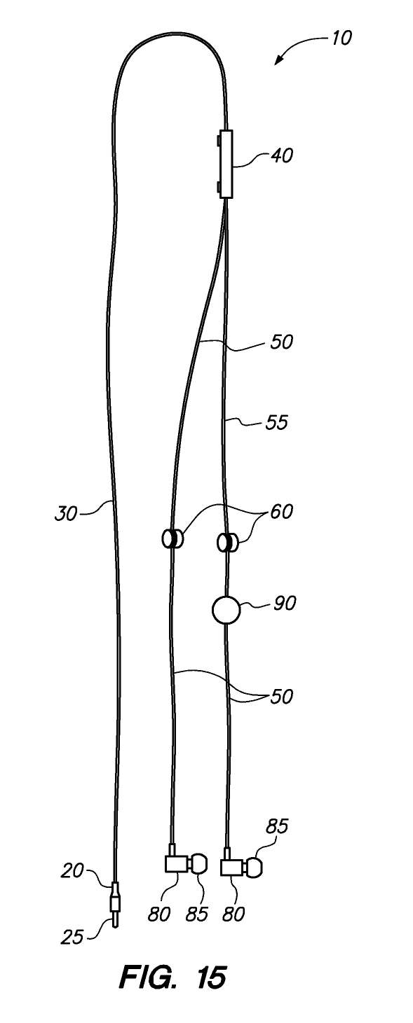

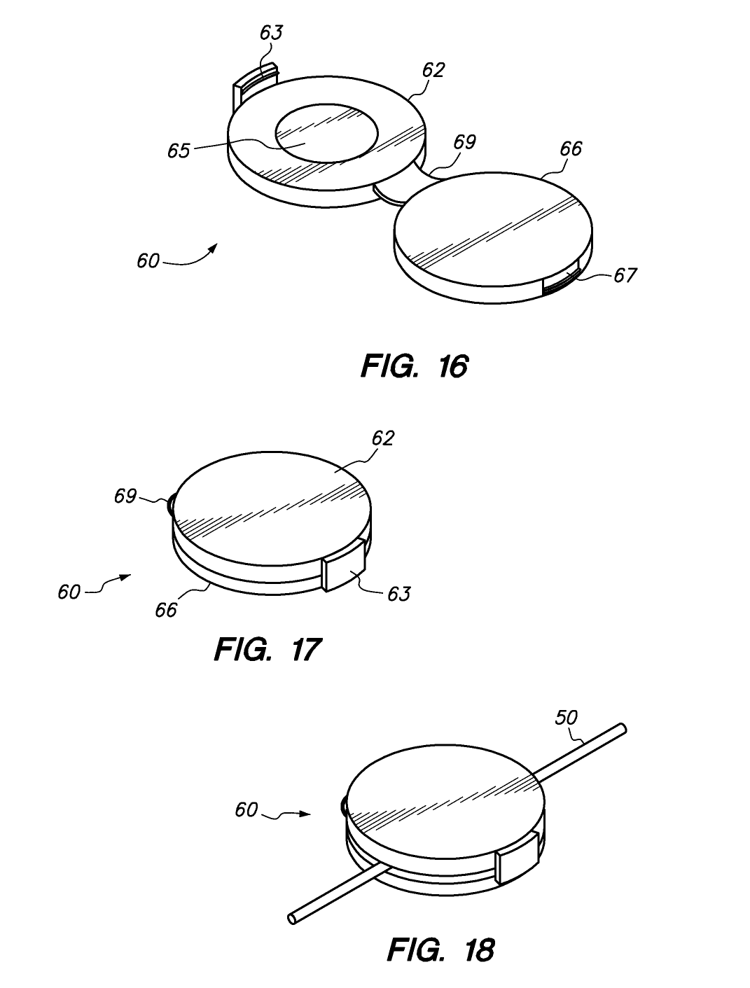

Microphone 90 may be located: on the Y-junction 40, on the length of four-conductor speaker wire 30, or on either length of two-conductor speaker wire 50. If microphone 90 is located on Y-junction, then the second end of four-conductor speaker wire 30 is coupled directly to the bottom end of Y-junction 40 and the first ends of the first and second lengths of two-conductor speaker wire 50 are coupled directly to top end of Y-junction 40 as described above and depicted in FIG. 13. If microphone 90 is located on the length of four-conductor speaker wire 30, then there is a second segment of four-conductor speaker wire 60, where one segment four-conductor speaker wire 60 runs between audio source electrical connector 20 and the microphone 90 and the other segment of four-conductor speaker wire 60 runs between the microphone 90 and Y-junction 40, as depicted in FIG. 14. If microphone 90 is located on either the first or second length of two-conductor speaker wire 50, then there must be an additional speaker wire segment 55 with at least three conductors therein running between Y-junction 40 and microphone 90 to enable the required electrical coupling of the microphone signal, loudspeaker signal, and ground signal to the audio source device. Therefore, in this mode, there is an additional speaker wire segment 55 with at least three conductors running between Y-junction 40 and microphone 9, as depicted in FIG. 15.

What is claimed is:

1. An earbud headphone set comprising: an audio source electrical connector; a length of four-conductor speaker wire; a Y-junction; a first and second length of two-conductor speaker wire; a first and second magnetic speaker wire clamp; and a first and second loudspeaker, wherein
said length of four-conductor speaker wire is a length of speaker wire with a first end, a second end, and at least four continuous strands of conductive material running from said first end to said second end that have electrical continuity from said first end to said second end and are electrically shielded from each other and from the outside with an insulation cover layer,
said audio source electrical connector is an oblong-shaped electrical connector with a first end and a second end, said first end comprising a jack plug or pin electrical connector that is electrically coupled to each of said at least four continuous strands of conductive material of said length of four-conductor speaker wire by a set of shielded electrical connections that are located at said second end of said audio source electrical connector,
said first end of said length of four-conductor speaker wire is rigidly attached to said second end of said audio source electrical connector, said Y-junction is an oblong-shaped rigid electrical connector with a top end and a bottom end,
said first and second lengths of two-conductor speaker wire are each a length of speaker wire with a first end, a second end, and at least two continuous strands of conductive material running from said first end to said second end that have electrical continuity from said first end to said second end and are electrically shielded from each other and from the outside with an insulation cover layer,
said second end of said length of four-conductor speaker wire is rigidly attached to said bottom end of said Y-junction, said first end of said first length of two-conductor speaker wire is rigidly attached to said top end of said Y-junction, and said first end of said second length of two-conductor speaker wire is rigidly attached to said top end of said Y-junction,
said at least two continuous strands of conductive material within said first length of two-conductor speaker wire each have electrical continuity with one specific strand of said at least four continuous strands of conductive material within said length of four-conductor speaker wire,
said at least two continuous strands of conductive material within said second length of two-conductor speaker wire each have electrical continuity with one specific strand of said at least four continuous strands of conductive material within said length of four-conductor speaker wire,
said first and second loudspeakers are each an electronic device capable of receiving electronic signals from an audio source device and electrically converting the electronic signals into correlated sound waves,
said second end of said first length of two-conductor speaker wire is rigidly attached to said first loudspeaker with electrical continuity between each of said at least two continuous stands of conductive material and said first loudspeaker,
said second end of said second length of two-conductor speaker wire is rigidly attached to said second loudspeaker with electrical continuity between each of said at least two continuous stands of conductive material and said second loudspeaker,
said first magnetic speaker wire clamp and said second magnetic speaker wire clamp each comprise a piece of magnetically charged solid material fully encapsulated by a solid cover layer or covering made of or formed from an insulating or non-conductive material,
said first magnetic speaker wire clamp is permanently attached to said first length of two-conductor speaker wire by over-molding, gluing, welding, bolting, or screwing said first magnetic speaker wire clamp to said first length of two-conductor speaker wire, and
said second magnetic speaker wire clamp is permanently attached to said second length of two-conductor speaker wire by over-molding, gluing, welding, bolting, or screwing said first magnetic speaker wire clamp to said first length of two-conductor speaker wire.

2. An earbud headphone set comprising: an audio source electrical connector; a length of four-conductor speaker wire; a Y-junction; a first and second length of two-conductor speaker wire; a first and second magnetic speaker wire clamp; and a first and second loudspeaker, wherein
said length of four-conductor speaker wire is a length of speaker wire with a first end, a second end, and at least four continuous strands of conductive material running from said first end to said second end that have electrical continuity from said first end to said second end and are electrically shielded from each other and from the outside with an insulation cover layer,
said audio source electrical connector is an oblong-shaped electrical connector with a first end and a second end, said first end comprising a jack plug or pin electrical connector that is electrically coupled to each of said at least four continuous strands of conductive material of said length of four-conductor speaker wire by a set of shielded electrical connections that are located at said second end of said audio source electrical connector,
said first end of said length of four-conductor speaker wire is rigidly attached to said second end of said audio source electrical connector, said Y-junction is an oblong-shaped rigid electrical connector with a top end and a bottom end,
said first and second lengths of two-conductor speaker wire are each a length of speaker wire with a first end, a second end, and at least two continuous strands of conductive material running from said first end to said second end that have electrical continuity from said first end to said second end and are electrically shielded from each other and from the outside with an insulation cover layer,
said second end of said length of four-conductor speaker wire is rigidly attached to said bottom end of said Y-junction, said first end of said first length of two-conductor speaker wire is rigidly attached to said top end of said Y-junction, and said first end of said second length of two-conductor speaker wire is rigidly attached to said top end of said Y-junction,
said at least two continuous strands of conductive material within said first length of two-conductor speaker wire each have electrical continuity with one specific strand of said at least four continuous strands of conductive material within said length of four-conductor speaker wire,
said at least two continuous strands of conductive material within said second length of two-conductor speaker wire each have electrical continuity with one specific strand of said at least four continuous strands of conductive material within said length of four-conductor speaker wire,
said first and second loudspeakers are each an electronic device capable of receiving electronic signals from an audio source device and electrically converting the electronic signals into correlated sound waves,
said second end of said first length of two-conductor speaker wire is rigidly attached to said first loudspeaker with electrical continuity between each of said at least two continuous stands of conductive material and said first loudspeaker,
said second end of said second length of two-conductor speaker wire is rigidly attached to said second loudspeaker with electrical continuity between each of said at least two continuous stands of conductive material and said second loudspeaker,
said first magnetic speaker wire clamp is reversibly slideably attachable and reversibly rigidly attachable to said first length of two-conductor speaker wire,
said second magnetic speaker wire clamp is reversibly slideably attachable and reversibly rigidly attachable to said second length of two-conductor speaker wire,
said first magnetic speaker wire clamp and said second magnetic speaker wire clamp each comprise: a male half with at least two tapered leader pins, a female half with at least two bushing holes, and a magnetic insert, wherein said magnetic insert is a piece of magnetically charged solid material that is encapsulated or partially encapsulated within said male half or said female half of each of said first and said second magnetic speaker wire clamps.

3. An earbud headphone set as recited in claim 2, wherein said first adjustable magnetic speaker wire clamp and said second adjustable magnetic speaker wire clamp each comprise 2-20 said tapered leader pins.

4. An earbud headphone set comprising: an audio source electrical connector; a length of four-conductor speaker wire; a Y-junction; a first and second length of two-conductor speaker wire; a first and second magnetic speaker wire clamp; and a first and second loudspeaker, wherein
said length of four-conductor speaker wire is a length of speaker wire with a first end, a second end, and at least four continuous strands of conductive material running from said first end to said second end that have electrical continuity from said first end to said second end and are electrically shielded from each other and from the outside with an insulation cover layer,
said audio source electrical connector is an oblong-shaped electrical connector with a first end and a second end, said first end comprising a jack plug or pin electrical connector that is electrically coupled to each of said at least four continuous strands of conductive material of said length of four-conductor speaker wire by a set of shielded electrical connections that are located at said second end of said audio source electrical connector,
said first end of said length of four-conductor speaker wire is rigidly attached to said second end of said audio source electrical connector,
said Y-junction is an oblong-shaped rigid electrical connector with a top end and a bottom end,
said first and second lengths of two-conductor speaker wire are each a length of speaker wire with a first end, a second end, and at least two continuous strands of conductive material running from said first end to said second end that have electrical continuity from said first end to said second end and are electrically shielded from each other and from the outside with an insulation cover layer,
said second end of said length of four-conductor speaker wire is rigidly attached to said bottom end of said Y-junction, said first end of said first length of two-conductor speaker wire is rigidly attached to said top end of said Y-junction, and said first end of said second length of two-conductor speaker wire is rigidly attached to said top end of said Y-junction,
said at least two continuous strands of conductive material within said first length of two-conductor speaker wire each have electrical continuity with one specific strand of said at least four continuous strands of conductive material within said length of four-conductor speaker wire,
said at least two continuous strands of conductive material within said second length of two-conductor speaker wire each have electrical continuity with one specific strand of said at least four continuous strands of conductive material within said length of four-conductor speaker wire,
said first and second loudspeakers are each an electronic device capable of receiving electronic signals from an audio source device and electrically converting the electronic signals into correlated sound waves,
said second end of said first length of two-conductor speaker wire is rigidly attached to said first loudspeaker with electrical continuity between each of said at least two continuous stands of conductive material and said first loudspeaker,
said second end of said second length of two-conductor speaker wire is rigidly attached to said second loudspeaker with electrical continuity between each of said at least two continuous stands of conductive material and said second loudspeaker,
said first magnetic speaker wire clamp is reversibly rigidly attachable to said first length of two-conductor speaker wire,
said second magnetic speaker wire clamp is reversibly rigidly attachable to said second length of two-conductor speaker wire,
said first magnetic speaker wire clamp and said second magnetic speaker wire clamp each comprise: a male half with a latch, a female half with a latch receiver, a hinge, and a magnetic insert, wherein said magnetic insert is a piece of magnetically charged solid material that is encapsulated or partially encapsulated within said male half or said female half of each of said first and said second magnetic speaker wire clamps.

5. An earbud headphone set as recited in claim 1, 2, 3, or 4 further comprising a microphone that is an electronic device capable of receiving sound waves and electrically converting the sound waves into correlated electronic signals, wherein said microphone is located within said Y-junction wherein said microphone has electrical continuity with at least two of said at least four continuous strands of conductive material within said length of four-conductor speaker wire.

6. An earbud headphone set as recited in claim 1, 2, 3, or 4 further comprising a microphone that is an electronic device capable of receiving sound waves and electrically converting the sound waves into correlated electronic signals, wherein said microphone is rigidly attached to said length of four-conductor speaker wire with electrical continuity with at least two of said at least four continuous stands of conductive material within said length of four-conductor speaker wire.

7. An earbud headphone set as recited in claim 1, 2, 3, or 4 further comprising a microphone that is an electronic device capable of receiving sound waves and electrically converting the sound waves into correlated electronic signals, wherein said microphone is rigidly attached to said first or said second length of two-conductor speaker wire with electrical continuity with at least one of said at least two continuous stands of conductive material within the length of two-conductor speaker wire there attached.
